(19) United States
(12) Patent Application Publication
(10) Pub. No.: US 2014/0180796 A1
(43) Pub. Date: Jun. 26, 2014

(54) SELECTING AND SERVING CONTENT ITEMS OF DIFFERENT CONTENT ITEM TYPES FOR A CONTENT ITEM SLOT

(71) Applicants: Sándor Sás, San Francisco, CA (US); Brandon Murdock Pearcy, San Francisco, CA (US); Nathan Peter Lucash, San Francisco, CA (US)

(72) Inventors: Sándor Sás, San Francisco, CA (US); Brandon Murdock Pearcy, San Francisco, CA (US); Nathan Peter Lucash, San Francisco, CA (US)

(21) Appl. No.: 13/725,302

(22) Filed: Dec. 21, 2012

(51) Int. Cl. G06Q 30/02

(52) U.S. Cl. CPC G06Q 30/0277
USPC 705/14.45; 705/14.73; 705/14.71

(57) ABSTRACT

In some instances, a resource may have display space, such as a content item slot, that is independent of the first-party content and that may be used for presenting third-party content items. Selection and serving of different types of content items may be used to maximize the space and/or to maximize user interaction with the content items. In one implementation, a dimensional height and width of a content item slot may be received. A spatial configuration for the content items slot may be determined. A minimum length for each content item type may be determined based on the size of the content item slot. A selection of content items of different types may be made based on the minimum lengths of each content item type and the size of the content item slot. Data to effect display of the selected content items may be output.

### BACKGROUND

In a networked environment such as the Internet or other networks, first-party providers can provide information for public display on resources, for example web pages, documents, applications, and/or other resources. The first-party content can include text, video, and/or audio information provided by the first-party providers via, for example, a content server for display on the Internet. Additional third-party content can also be provided by third-party content providers for display on the resources together with the information provided by the first-party providers. Thus, a person viewing a resource can access the information that is the subject of the resource, as well as the third-party content that may or may not be related to the subject matter of the resource.

### SUMMARY

In one implementation, a method for providing content items of different types for a content item slot may include receiving data indicative of the size of a content item slot of a resource. The data may include at least one of a dimensional height and width of the content item slot. A determination of a spatial configuration for the content items for the content item slot may be made. Minimum lengths for each content item type of a plurality of content item types may be determined based, at least in part, on the data indicative of the size of the content item slot. Two or more content items may be selected based, at least in part, on the determined minimum length for each content item type and the data indicative of the size of the content item slot. The two or more content items may include a first content item of a first content item type and a second content item of a second content item type with the first content item type and the second content item type being different. Data to effect display of the selected two or more content items may be output.

In one implementation, a system for providing one or more content items for a non-standard content item slot may include one or more data processors and one or more storage devices storing instructions that cause the data processors to perform various operations. The operations may include receiving a dimensional height and a dimensional width of a content item slot of a resource. A determination of a spatial configuration for content items for the content item slot may be made. A minimum length for each content item type of several content item types may be determined based, at least in part, on the spatial configuration. A selection of several content items may be based on the determined minimum length for each content item type and the dimensional height and width of the content item slot. The selected content items may include at least two content items of different content item types. Data to effect display of the selected content items may be output.

In still another implementation, a computer-readable storage device may store instructions that cause one or more data processors to perform several operations. The operations may include receiving a dimensional height and a dimensional width of a content item slot of a resource. A minimum length for each content item type of several content item types and for each spatial configuration may be determined based, at least in part, on the dimensional height or width of the content item slot. A spatial configuration may be determined based, at least in part, on the determined minimum lengths. A selection of two or more content items may be based on the determined minimum length for each content item type and the dimensional height and width of the content item slot. The selected content items may include a text content item type content item and an image content item type content item. The text content item type content item may be converted into an image content item type content item. Data to effect display of the converted text content item type content item and the image content item type content item may be output.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram illustrating an example system for distributing content items for display with a resource via a computer network;

FIGS. 2A-B are flow diagrams illustrating example processes for distributing content items for display with a resource via a computer network;

FIG. 3 illustrates an example resource having several different content items of different content item types displayed with first-party content;

FIGS. 4A-4E illustrate several examples of hybrid content item slots displaying several content items of different content item types;

FIG. 5 is a flow diagram of an example method for determining content items of different content item types for display in a hybrid content slot;

FIG. 6 shows an illustration of an example network environment comprising client machines in communication with remote machines in accordance with an illustrative embodiment; and

FIG. 7 is a block diagram illustrating an architecture for a computer system that may be employed to implement various elements of the systems and methods.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and embodiments of, methods, apparatuses, and systems for providing information on a computer network. The various concepts introduced above and discussed in greater detail below may be implemented in any of numerous ways, as the described concepts are not limited to any particular manner of implementation. Examples of specific implementations and applications are provided primarily for illustrative purposes.

When users request resource data to effect display of a resource on a user device, third-party content items may be displayed with the first-party content of the requested resource. As used herein, a “hybrid content item slot” may refer to a section of the resource that displays a combination of content items (e.g., advertisements) of different content item types including text, images (i.e., content items having a picture), animated images, videos (e.g., videos in Adobe Flash Player format), link units, or any other type of content. A link unit shows keyword links, that are related to the first-party content of the requested resource and/or to the third-party content items displayed in the hybrid content item slot, and that have content items (e.g., advertisements) associated with them. Clicking on a link unit causes the user device to request a resource having a list of content items that match the keyword in the link.

The hybrid content item slot can display a combination of different types of content items. The different content item types can include a text content item type, an image content item type, a video content item type, an animated image content item type, a flash content item type, a link unit content item type, a block of link unit content item type, etc. For example, the hybrid content item slot can include two image advertisements, one text advertisement, and a block of link units.

The combination of content items for inclusion in the hybrid content item slot may be based on dimensional size data associated with the hybrid content item slot and dimensional size data computed for each content item type. In some implementations, a stacking configuration may be determined based on the dimensional size data associated with the hybrid content item slot. For example, if the height of the hybrid content item slot is larger than its width, then a vertical stacking configuration of content items may be used. On the other hand, if the hybrid content item slot width is larger than its height, then a horizontal configuration may be utilized. In other implementations, the stacking configuration can be determined using other types of algorithms.

Once the stacking configuration is determined, dimensional size data for each content item type (e.g., minimum height and/or width) is computed using a distribution of sizes for the various content item types. For example, with a vertical stacking configuration, it may be determined that a text content item requires a minimum height of 100 pixels, that an image content item requires a minimum height of 200 pixels, and that a link unit requires a minimum height of 50 pixels.

Taking into account these constraints (i.e., the dimensional size data for each content item type, and the dimensional size data associated with the hybrid content item slot), a combination of content items may be determined for the hybrid content item slot. Other factors may be utilized in selecting the content items, such as various performance metrics (e.g., a click-through-rate for the various content item types).

For example, a hybrid content item slot for a resource can be 160 pixels wide and 600 pixels high. In this example, using the method described herein, two image content items for a width of 160 pixels and having a combined height of 400 pixels, one text content item for a width of 160 pixels and having a height of 100 pixels, and two link units for a width of 160 pixels and having a total height of 100 pixels can be selected from several content items to be rendered in the hybrid content item slot with the resource. As a result, the selected content items account for a total height of 600 pixels, which does not exceed the height of the hybrid content item slot (i.e., 600 pixels). Further examples of the selection of content items for the hybrid content item slot will be described in greater detail herein.

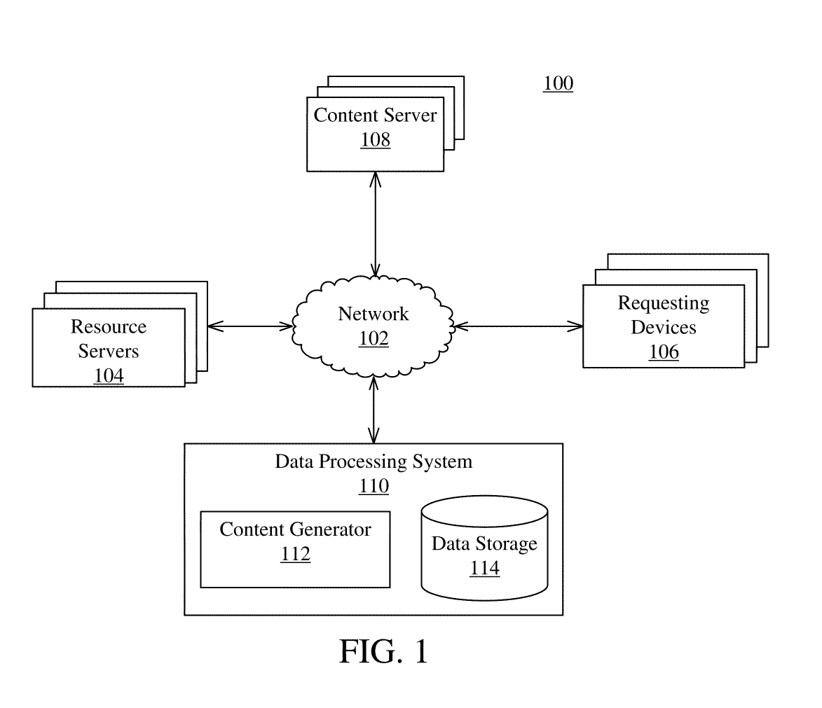

FIG. 1 illustrates an example system 100 for providing information via at least one computer network, such as the network 102. The network 102 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, the network 105 may include a wireless link, such as an infrared channel or satellite band. The topology of the network 105 may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some implementations, different types of data may be transmitted via different protocols. In other implementations, the same types of data may be transmitted via different protocols.

The resource server 104 can include a computer having a server configured to host at least one resource, such as a web page or other resource. Resources can include web pages, word processing documents, portable document format (PDF) documents, images, video, programming elements, interactive content, and feed sources, to name only a few. Each resource of the resource server 104 may be associated with a domain name. The resource may be identified by a resource address that may be associated with the resource, such as a URL. Resources include content, such as words, phrases, images and sounds, that may include embedded information (such as meta-information in hyperlinks) and/or embedded instructions. Embedded instructions can include code that is executed at a requesting device 106, such as in a web browser. Code can be written in languages, such as, JavaScript® or ECMAScript®.

The resource server 104 may be a computer server (e.g., an FTP server, file sharing server, web server, etc.) or a combination of servers (e.g., a data center, a cloud computing platform, etc.). The resource server 104 can provide resource data or other content (e.g., text documents, PDF files, and other forms of electronic documents) to the requesting device 106. In one implementation, the requesting device 106 can request resource data from the resource server 104 via the network 102 to effect display of the resource on a display of the requesting device 106.

The requesting device 106 may include one or more interface devices (e.g., a laptop, desktop, tablet, personal digital assistants, smart phones, portable computer, etc.). An interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more interface devices may be internal to a housing of the requesting device 106 (e.g., a built-in display, microphone, etc.) or external to the housing of the requesting device 106 (e.g., a monitor or speaker connected to the requesting device 106, etc.), according to various implementations. For example, the requesting device 106 may include an electronic display capable of displaying resources, such as web pages, or other resource or content data received from a resource server 104, content server 108, and/or data processing system 110. A web browser of the requesting device 106 can be used to request resource data from a resource server 104 of a first-party content provider for display on a display of the requesting device 106.

For situations in which the systems discussed here collect information about users, or may make use of information about users, the users may be provided with an opportunity to control whether programs or features that may collect user information (e.g., information about a user's social network, social actions or activities, a user's preferences, a user's device configuration, or a user's current location), or to control whether and/or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

Content server 108 may include one or more devices connected to network 102 that provide content items. The content items may include images, flash animations, video or graphical content, text-based content, or any combination thereof. In one implementation, the content server 108 may be an advertiser and the content items may include advertisements. However, the systems and methods may also be applied to any other type of content server 108 and/or content item.

The system 100 may include at least one data processing system 110. The data processing system 110 can include at least one logic device, such as a computing device having a processor, to communicate via the network 102, for example with the resource server 104, the requesting device 106, and/or the content server 108. The data processing system 110 can include one or more data processors or processing modules, such as a content generator 112. Data processing system 110 may also include a data storage 114 for storing data. In some embodiments, the data processing system 110 may include a frontend server and a backend server.

In some implementations, the content generator 112 can process a request for content items from a web browser of a requesting device 106, and return data for content items of various different content item types to be placed in a hybrid content item slot of the resource. In some implementations, the request may include dimensions (e.g., height and/or width) of the hybrid content item slot.

Data storage 114 may be configured to organize, store, retrieve, and transmit data. In some embodiments, the data storage 114 can store data about content items provided by a content server 108. For example, the data storage 114 may store the content items provided to a resource server 104 and/or a requesting device 106. The data storage 114 can be configured to interact with any component of the system 100 including the data processing system 110, the content generator 112, the content server 108, the resource server 104, or requesting device 106.

In one implementation, the data processing system 110 can receive, via the network 102, a request for a content item to display with a resource. In one implementation, the resource may include a web page. The resource server 104 may include first party provider of a resource, who may have an agreement with the data processing system 110 for the system to provide content items to display with one or more resources of the resource server 104. In some implementations, the resource server 104 can request content, such as third-party content items, from the data processing system 110 to be displayed with the requested resource. In some other implementations, the requesting device 106 may be a computing device operated by a user (represented by a device identifier), which, when accessing a resource of the resource server 104, can request to the data processing system 110 for content to be displayed with the resource.

The data processing system 110 may request content from the content server 108 in response to this request for content. The data processing system 110 may select the content items to provide to the resource server 104 or the requesting device 106 based on a plurality of factors. In some implementations, the data processing system 110 may instruct the content server 108 to directly provide the content items to the resource server 104. In other embodiments, the data processing system 110 may retrieve one or more content items from the content server 108 and store the content items in the data storage 114. The data processing system 110 may receive the request in real-time, e.g., between the time that the requesting device 106 requests resource data to effect display of a resource of the resource server 104 and the time that resource is displayed on a display of the requesting device 106.

As will be described in greater detail below, the data processing system 110 may receive hybrid content item slot information via the computer network 102 for a resource provided by resource server 104. For example, the data processing system 110 may receive data associated with the hybrid content item slot that may include a slot id, a position of the slot in the document object model (DOM) of the resource, parameters for a slot length and/or width, or the like. In some instances, the data processing system 110 can obtain hybrid content item slot information from a web browser of the requesting device 106.

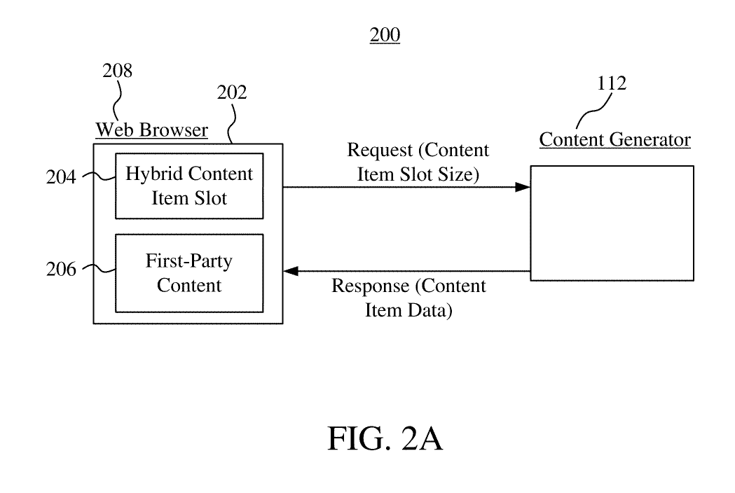

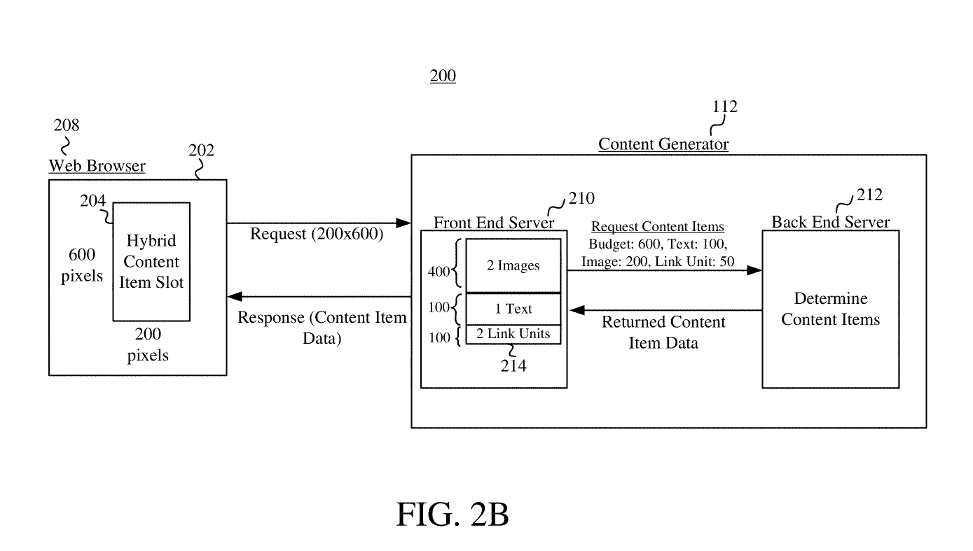

FIG. 2A illustrates a flow diagram of a process 200 for providing content items for display with a resource 202, such as a web page, loaded by a web browser 208 via a computer network (e.g., network 102). As shown, the resource 202 includes a hybrid content item slot 204 and first-party content 206. In some embodiments, the hybrid content item slot 204 includes a combination of different types of content items, such as advertisements, provided by a content server 108, while the first-party content 206 includes resource content (e.g., text, images, videos, etc.) provided by a resource server 104. The web browser 208 may transmit a request for content, such as content items, to the content generator 112. The request can include information regarding the hybrid content item slot 204, including dimensional data of the hybrid content item slot 204 (e.g., hybrid content item slot height and/or width). For example, the hybrid content item slot 204 can have dimensions of 200 pixels wide by 600 pixels high.

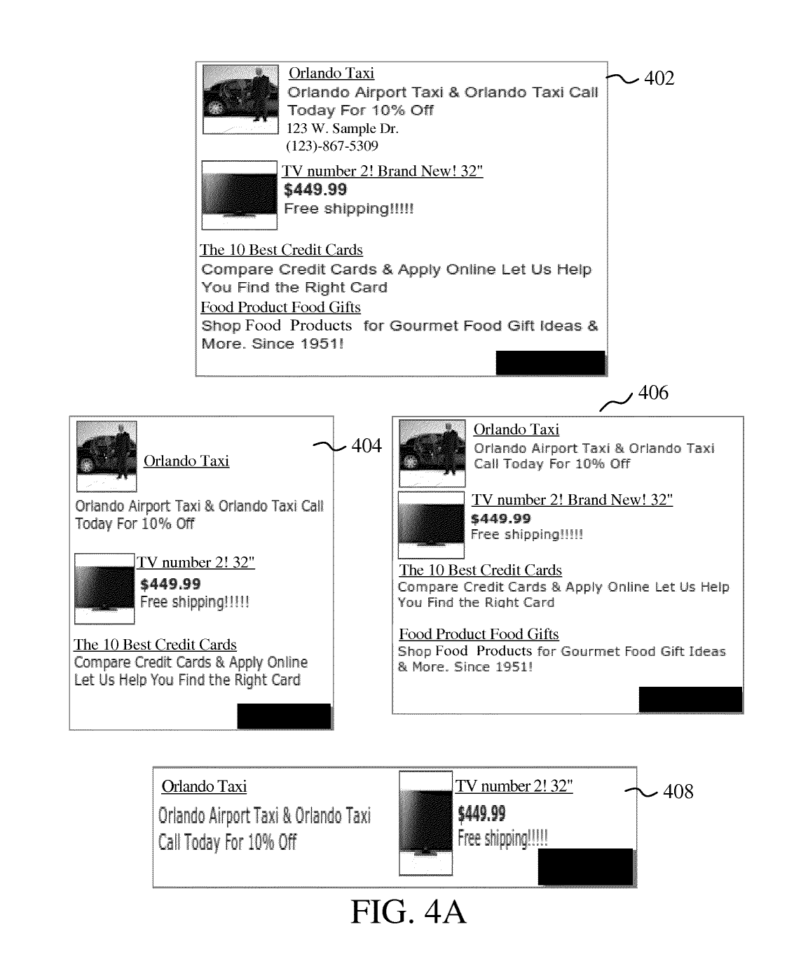

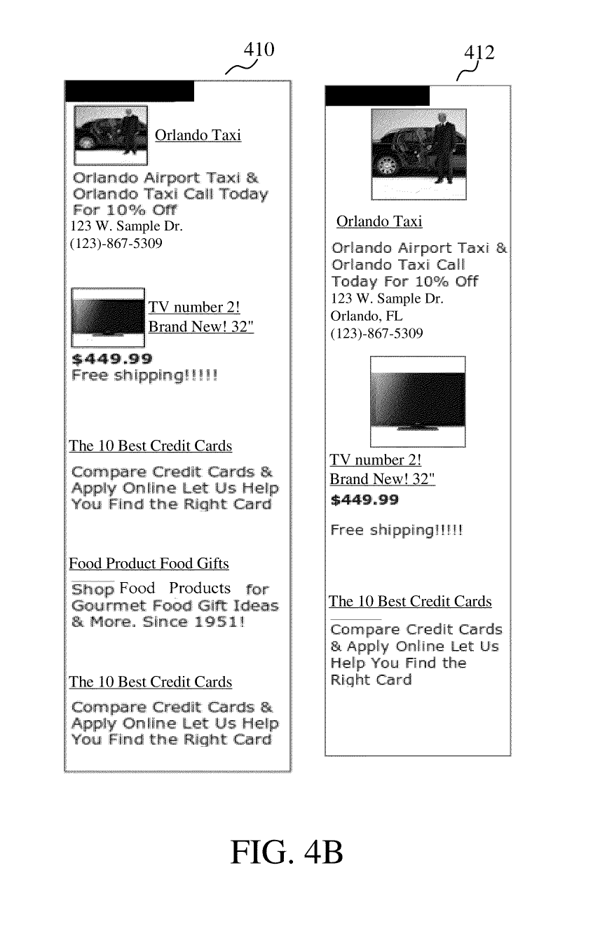

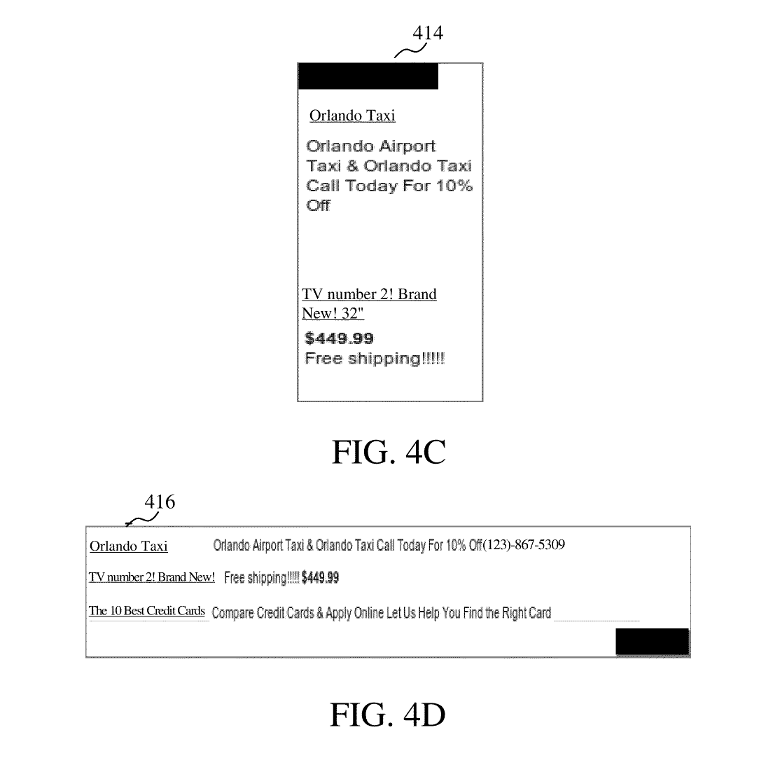

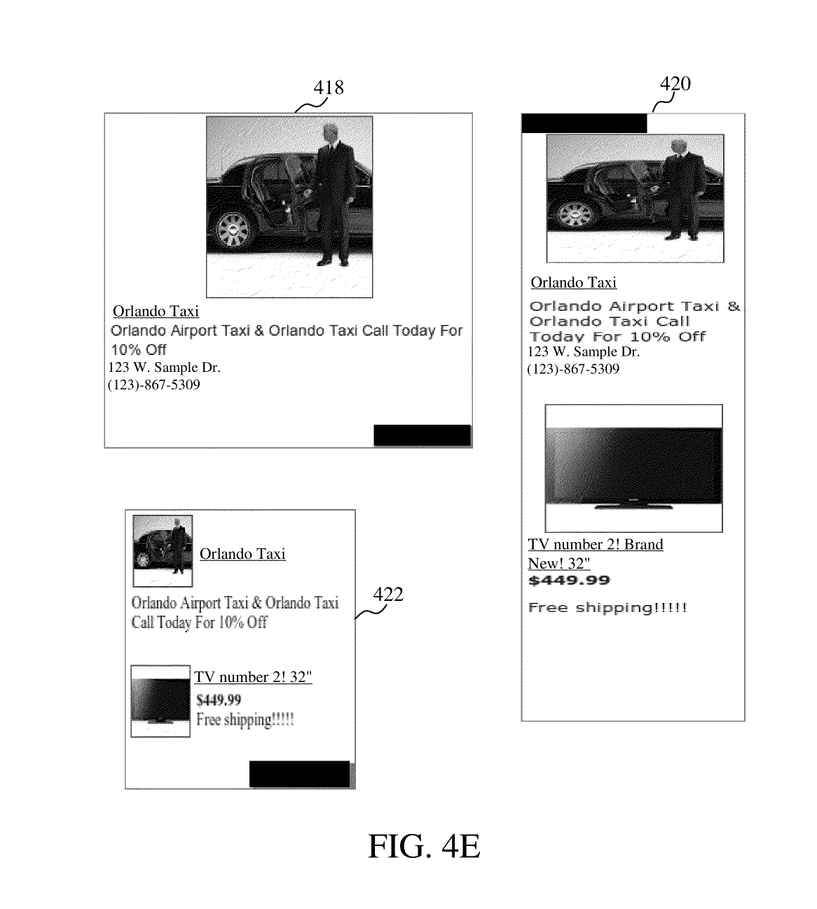

Based upon at least the dimensional data of the hybrid content item slot 204 in combination with other factors (e.g., predetermined size for different types of content items), the content generator 112 may select one or more content items from several content items to be rendered in the hybrid content item slot 204 and to be displayed with the resource on a display of a requesting device 106. The selected content items can include content items of different types. For example, the selected content items can include four text content items and two image content items. FIGS. 4A-4E illustrate examples of hybrid content item slots 204 having content items of different types. The content generator 112 may transmit data to effect display of the selected content items to the web browser 214 of a requesting device 106. In some implementations, the transmitted data may include both positional data and display data for each content item to be displayed such that the requesting device 106 may render the content items in a determined configuration.

FIG. 2B illustrates a further configuration for the content generator 112 having a front end server 210 and a back end server 212. In the present example, the hybrid content slot 204 has a height of 600 pixels and width of 200 pixels. In response to receiving resource data for a resource 202 from a resource server, a web browser 208 of the requesting device may transmit a request for content items to be rendered in a hybrid content item slot 204 of the resource to the content generator 112. The request may include data indicative of the 200 pixel dimensional width and 600 pixel dimensional height of the hybrid content item slot 204. In some instances, the request for content items may be received from a resource server 204 and/or otherwise.

As illustrated, the content generator 112 can utilize a front end server 210 and a back end server 212. In other implementations, the functionality performed by the servers 210 and 212 can be performed by a single server, or alternatively, by more than two servers. In the illustrated implementation, the front end server 210 receives the request and the dimensional data from a web browser 208 of the requesting device.

The front end server 210 may determine a spatial configuration for the content items to be displayed in the hybrid content item slot 204 using the dimensional data of the hybrid content item slot 204. For example, content items may be spatially positioned in a horizontal arrangement or vertically arrangement. As shown in FIG. 2B, the example hybrid content item slot 204 is 200 pixels wide and 600 pixels high. Thus, because the hybrid content item slot 204 is more tall than wide, the front end server 210 may choose a vertical arrangement for the content items.

Of course other methods of determining the spatial configuration may be used as well. For example, data may indicate that a vertical arrangement of content items may result in a higher click-through-rate than a horizontal arrangement of content items. Thus, the front end server 210 may select a vertical arrangement for the content items if the height dimension of the hybrid content item slot 204 exceeds a specific value (e.g., 100 pixels). In other implementations, the spatial configuration may be selected based upon a maximization of content items displayed in the hybrid content item slot 204. In still other implementations, the spatial configuration may be iteratively or otherwise determined based on both the dimensional data for the hybrid content item slot 204 and the minimum lengths (e.g., a minimum height or width) for each content item type, as will be discussed in greater detail herein. For example, for a hybrid content item slot 204 having a 400 pixel width and 400 pixel height, the spatial configuration for the content items may be determined based the dimensional data for the hybrid content item slot 204 and the minimum lengths for each content item type such that the 400 pixel by 400 pixel space is maximized (e.g., a vertical arrangement may permit two image content items and two text content items while a horizontal arrangement permits two image content items). Of course any or all of the foregoing may be combined for the determination of the spatial configuration.

Referring back the current example, once a spatial configuration is determined for the content items to be displayed in the hybrid content item slot 204, the front end server 210 may determine a content item size for each content item type. The content item size may include a minimum length that can be representative of either content item height or width. In some instances, the minimum length may be determined based on the determined spatial configuration (i.e., vertical or horizontal arrangement).

For instance, when a horizontal arrangement is determined, the minimum length may represent a content item type minimum width based on a dimensional height of the hybrid content item slot 204. For example, a hybrid content item slot 204 having dimensions of 200 pixels high by 600 pixels wide may result in a determination that an image content item type having a height of 200 pixels has a minimum length of 100 pixels wide. Similarly, a text content item type having a height of 200 pixels may have a minimum length of 50 pixels. A link unit having a height of 200 pixels may also have a minimum length of 50 pixels. Such minimum lengths may be determined based on statistical data and/or based on a curve fit to the statistical data. For example, statistical data for several image content item type content items may indicate that 95% of image content item type content items having a height of 200 pixels have a width of 100 pixels or less. If the height dimension was 300 pixels instead of 200 pixels, the computed minimum length may instead be 75 pixels. Such statistical data may be used to determine the minimum lengths for other content item types. The different content item types can include a text content item type, an image content item type, a video content item type, an animated image content item type, a flash content item type, a link unit content item type, a block of link unit content item type, etc. In some instances, the determined minimum lengths may depend on a configuration of the requesting device (e.g., a web browser type, a web browser version, an operating system, a language, a font size, a font type, etc.). Such configuration information may be received with the request for content items. In some instances, the minimum length may be based, at least in part, on a click-through-rate (e.g., content items having a minimum length of 100 pixels have a click-through-rate of 8% while content items having a minimum length of 50 pixels have a click-through-rate of 4%).

Similarly, when a vertical arrangement is determined, the minimum length may represent a content item type minimum height based on a dimensional width of the hybrid content item slot 204. For example, a hybrid content item slot 204 having dimensions of 600 pixels high by 200 pixels wide may result in a determination that an image content item type having a width of 200 pixels has a minimum length of 200 pixels high. Similarly, a text content item type having a width of 200 pixels may have a minimum length of 100 pixels. A link unit having a width of 200 pixels may have a minimum length of 50 pixels. Such minimum lengths may be determined based on statistical data and/or based on a curve fit to the statistical data. For example, statistical data for several image content item type content items may indicate that 95% of image content item type content items having a width of 200 pixels have a height of 100 pixels or less. If the width dimension was 100 pixels instead of 200 pixels, the computed minimum length may instead be 150 pixels. Such statistical data may be used to determine the minimum lengths for other content item types. In some instances, the determined minimum lengths may depend on a configuration of the requesting device (e.g., a web browser type, a web browser version, an operating system, a language, a font size, a font type, etc.). Such configuration information may be received with the request for content items.

In the example shown, the hybrid content item slot 204 has a dimensional height of 600 pixels and a dimensional width of 200 pixels and a vertical arrangement has been determined. Using such data, the front end server 210 may determine that the minimum length for an image content item type is a 200 pixel height based on the 200 pixel width. The minimum length for a text content item type is a 100 pixel height based on the 200 pixel width. The minimum length for a link unit content item type is a 50 pixel height based on the 200 pixel width. In the present example, data is sent to a back end server 212 to determine the content items and/or content item types for the hybrid content item slot 204. For instance, data indicative of a dimension of the hybrid content item slot 204 (e.g., a height dimension if the minimum lengths correspond to heights for the content item types or a width dimension if the minimum lengths correspond to widths for the content item types) and the various minimum lengths may be transmitted from the front end server 210 to the back end server 212. In some instances, the data may include both the height and width dimensions of the hybrid content item slot 204. In still further versions, the data may include the height and width dimensions of the hybrid content item slot 204 and the minimum lengths corresponding for both the height and width of the content item types (i.e., the minimum lengths based on the width of the hybrid content item slot 204 and the minimum lengths based on the height of the hybrid content item slot 204) such that the back end server 212 may determine, a spatial configuration, the content item types, and the content items for each type.

Based on the data received from the front end server 210, the back end server 212 may determine a combination of content item types and/or content items to be displayed in the hybrid content item slot 204. In some implementations, the content items and content item types may be selected using a content item auction, such as an advertisement auction. For example, for a hybrid content item slot 204 having dimensions of 200 pixels wide by 600 pixels high and content item types having minimum lengths of 200 pixels for an image content item type, 100 pixels for a text content item type, and 50 pixels for a link unit content item type, an auction may determine that highest scoring combination is for two image content item type content items, a text content item type content item, and two link unit content item type content items. In some instances, the auction score may be based on a bid and/or a quality score. In some other instances, the content item types may be determined by front end server 210 and/or otherwise determined prior to the content item auction. Thus, back end server 212 may select the content items for each content item type via a content item auction.

The total length of the content items selected by the back end server 212 may be less than or equal to an allocated budget, such as a dimension of the hybrid content item slot 204 (i.e., the height of the hybrid content item slot 204 if the content items are vertically arranged, or the width of the hybrid content item slot 204 if the content items are horizontally arranged). In some instances, the total length of the selected content items may be greater than the dimension of the hybrid content item slot 204 and one or more content items may be reduced in size to fit within the hybrid content item slot 204 (e.g., by shrinking a content item or by cropping a content item). In other instances, the total length of the selected content items may be less than the dimension of the hybrid content item slot 204 and one or more content items may be increased in size.

In some instances, the determination may be based on additional factors. For example, an additional factor may include a click-through-rates for the different content item types. In some instances, the content item types for the hybrid content item slot 204 may be specified by the resource data from the resource server 104 and/or by the first-party content provider.

The back end server 212 may transmit data for the selected content items to the front end server 210. Such data may include positional data (e.g., the order of the content items in the hybrid content item slot 204) and/or display data. The front end server 210, in turn, may transmit the data to effect display of the selected content items to a requesting device 106 having a web browser 208 for rendering in the hybrid content slot 204. In some instances, the data to effect display of the selected content items may be transmitted to a resource server 104 instead of to the requesting device. The selected content items may be rendered by the requesting device 106 for display in the content item slot 204 with the requested resource 202 on a display of the requesting device 106. Of course the foregoing process 200 is merely an example.

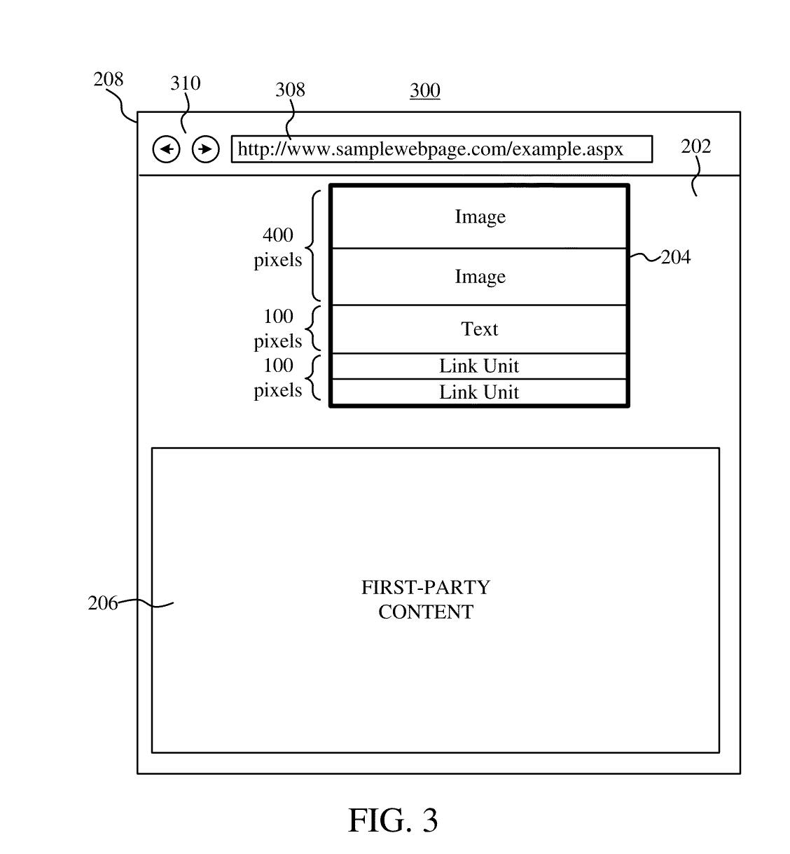

As shown in FIG. 3, the display data transmitted to effect display of the content items using the web browser 208 of a requesting device 106 from the content generator 112 may be rendered in the hybrid content slot 204. One or more processors in communication with a display 300 (e.g., display 200 is part of a requesting device 106) may execute a software application, such as the web browser 208, to effect display of the served content items from content generator 112 of data processing system 110. In the present example, the web browser 208 may operate by receiving input of a resource name or network address into a field 308, such as a web address, from an input device (e.g., a pointing device, a keyboard, a touch screen, etc.). In response, one or more processors associated with the requesting device 106 and executing the web browser 208 may request data over a network (e.g., the Internet, an intranet, etc.) from a resource server 104 for the resource name or network address.

The resource server 104 may provide resource data and/or other data, including a hybrid content item slot 204 and other first-party content 206, to the requesting device 106 which is used to cause visual indicia to be displayed to the user. The first-party content 206 may include photos, text, hyperlinks, layout information, and other data. In some embodiments, the first-party content 206 may include one or more files in a markup language, such as the hypertext markup language (HTML), extensible HTML (XHTML), extensible markup language (XML), or any other markup language.

The web browser 208 may provide display data to the display 300, which may include a number of navigational controls. For example, the web browser 208 may include the ability to go back or forward to other resources using inputs 310 (e.g., a back button, a forward button, etc.). In various embodiments, inputs 310 may cause the requesting device 106 to request resource data again from a resource server 104 and/or may cause the requesting device 106 to retrieve previously displayed resource data from a local cache.

The resource 202 may be hosted on a resource server 104 and may be operated by a first-party content provider. The resource data of resource 202 may be configured to cause a requesting device 106 to request third-party content items for display in a hybrid content item slot 204 with first-party content 206 and/or to cause resource server 104 to request third-party content items for display in a hybrid content item slot 204 with first-party content 206. As shown, the hybrid content item slot 204 includes two image content items, one text content item, and two link unit content items. The two image content items are 400 pixels high, as determined by the front end server 210, while the one text content item is 100 pixels high. The remaining 100 pixels of the hybrid content item slot 204 are allocated to two link unit content items. Accordingly, the content items determined by the content generator 112 for three different content item types are displayed in the hybrid content item slot 204.

FIGS. 4A-4E illustrate several hybrid content item slots with various combinations of different types of content items. The size of each hybrid content item slot can at least in part depend on the layout of a resource for the hybrid content slot. The content items shown in each hybrid content item slot may be determined by the content generator 112 based, at least in part, on the hybrid content item slot dimensions as well as the minimum length for each content item type based on the dimensions of the hybrid content item slot.

As shown in FIG. 4A, hybrid content item slots 402, 404, 406, and 408 various spatial configurations for image content item type content items and text content item type content items. For example, each of the hybrid content item slots 402 and 406 include two image content item type content items and two text content item type content items in a vertical spatial configuration for two different-sized hybrid content item slots. The hybrid content item slot 404 includes two image content item type content items and one text content item type content item, while the hybrid content item slot 408 depicts a horizontal spatial configuration that includes one text content item type content item and one image content item type content item. The shown hybrid content item slots 402, 404, 406, 408 are of different sizes and include different combinations and configurations for different content item types.

FIG. 4B illustrates two elongate vertical hybrid content item slots 410, 412. The two hybrid content item slots 410, 412 display a combination of image content item type content items and text content item type content items in a vertical arrangement. The hybrid content item slot 410 includes two image content item type content items and three text content item type content items, while the hybrid content item slot 412 includes two image content item type content items and one text content item type content item. The two hybrid content item slots 410, 412 and the content items shown are of different sizes. In FIG. 4C, hybrid content item slot 414 displays two text content item type content items shown in a vertical spatial configuration. FIG. 4D illustrates an elongate horizontal hybrid content item slot 416 displaying three text content item type content items in a vertical spatial configuration. Finally, FIG. 4E displays hybrid content item slots 420, 422, 424 including carious configurations for image content item type content items.

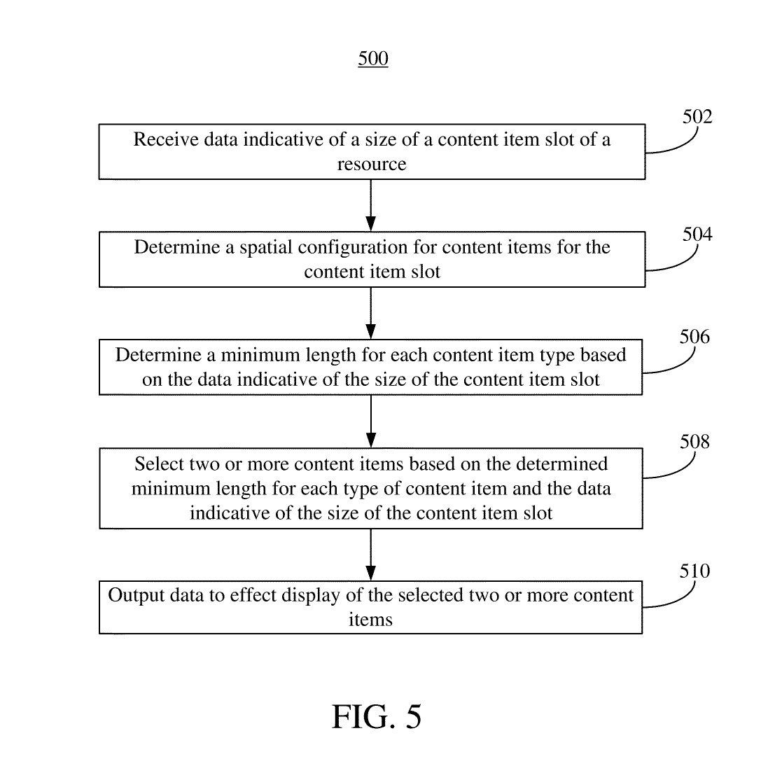

FIG. 5 is a flow diagram of a method 500 for selecting and serving content items of different content item types for placement in a content item slot of a resource. The method 500 may be implemented on a computing device (e.g., laptop, desktop, smart mobile phone, etc.). In one implementation, the method 500 may be encoded on a computer-readable storage medium that contains instructions that, when executed by a processor of a computing device, cause the computing device to perform operations of the method 500.

The method 500 includes receiving data indicative of a size of a content item slot of a resource (step 502). In some instances, the size data may be included with a received request for content items from a resource server or a requesting device to a data processing system or a processing module of the data processing system, such as a content generator. The request for content can be in HTTP format and/or other formats. The received data may further indicate that the content item slot is a hybrid content item slot. In some instances, the received data may also include a spatial configuration and/or may include data indicative of various content item types for the content item slot. The size data may include a dimensional height and a dimensional width for the content item slot. For example, the dimensional height may be a pixel value, such as 600 pixels, and the dimensional width may be a pixel value, such as 160 pixels. Of course other measurement standards other than pixels may be used. In the present example, the hybrid content slot is thus 160 pixels wide and 600 pixels tall.

A spatial configuration for content items for the content item slot may be determined (step 504). In some implementations, the spatial configuration may be determined based on the received data indicative of the size of the hybrid content slot. For example, the spatial configuration may be determined based on a comparison of the dimensional width and the dimensional height of the content item slot. If the dimensional height is larger than the dimensional width, then the spatial configuration may be determined to be a vertical arrangement. Similarly, when the dimensional width is larger than the dimensional height, a horizontal arrangement may be determined.

Of course other methods of determining the spatial configuration may be used as well. For example, data may indicate that a vertical arrangement of content items may result in a higher click-through-rate than a horizontal arrangement of content items. Thus, the spatial configuration may be determined to be a vertical arrangement if the dimensional height of the content item slot exceeds a specific value (e.g., 100 pixels). If the dimensional height does not exceed the value, a horizontal arrangement may be determined. In other implementations, the spatial configuration may be selected based upon a maximization of the number content items displayed in the content item slot. In still other implementations, the spatial configuration may be iteratively or otherwise determined based on both the dimensional sizes of the hybrid content item slot and minimum lengths (e.g., minimum heights or widths) for each content item type. For example, for a hybrid content item slot having a 400 pixel width and 400 pixel height, the spatial configuration for the content items may be determined based the dimensional data for the hybrid content item slot and the minimum lengths for each content item type such that the 400 pixel by 400 pixel space is maximized (e.g., a vertical arrangement may permit two image content items and two text content items while a horizontal arrangement permits two image content items). Of course any or all of the foregoing may be combined for the determination of the spatial configuration.

The method 500 may include determining a minimum length for each content item type based, at least in part, on the received data indicative of the size of the content item slot (step 506). The minimum length can be either a minimum width or a minimum height, depending on whether vertical or horizontal arrangement is determined. The minimum lengths may be determined based on statistical data and/or based on a curve fit to the statistical data. In some instances, the minimum length may be determined based on a curve fit to the statistical data based on a probability that content items of that type will have a dimension equal to or less than the value indicated by the curve. For example, statistical data for several image content item type content items may indicate that 95% of image content item type content items having a height of 200 pixels will have a width of 100 pixels or less. Such statistical data analysis may be used to determine the minimum lengths for other content item types. The different content item types can include a text content item type, an image content item type, a video content item type, an animated image content item type, a flash content item type, a link unit content item type, a block of link unit content item type, etc. In some instances, the determined minimum lengths may depend on a configuration of the requesting device (e.g., a web browser type, a web browser version, an operating system, a language, a font size, a font type, etc.). Such configuration information may be received with the data indicative of the size of the content item slot and/or with a request for content items. In some implementations, a smallest font size for a content item may be used when determining the minimum length for each content item type.

In one example, when a vertical arrangement is determined, the minimum length may include a minimum height for each content item type. For example, for a hybrid content item slot having dimensional width of 160 pixels and a dimensional height of 600 pixels, a text content item type content item may be determined to require a minimum height of 100 pixels for the width of 160 pixels, an image content item type content item may be determined to require a minimum height of 200 pixels for the width of 160 pixels, and a block of link unit content item type content items may be determined to require a minimum height of 50 pixels. Of course, other determinations for the minimum lengths for various content item types may be made.

In other implementations, fixed dimensions for the content item sizes for the various content item types may be used. For example, an image content item type can have content item sizes of 300 pixels by 200 pixels, 200 by 100 pixels, or 200 by 300 pixels. In another example, a link unit content item type can have a content item size of 25 pixels by 200 pixels. Thus, the minimum lengths may be determined from a set of known values.

Two or more content items may be selected based on the determined minimum length for each content item type and the data indicative of the size of the content item slot (step 508). The two or more content items may include content items of at least two content item types. For example, the two or more content items can include a combination of image content item type content items, text content item type content items, and link unit content item type content items (e.g., content items such as those shown in FIG. 3).

In some implementations, the two or more content items may be selected using a content item bidding auction, such as an advertisement auction. For example, for a hybrid content item slot having dimensions of 200 pixels wide by 600 pixels high and content item types having minimum lengths of 200 pixels for an image content item type, 100 pixels for a text content item type, and 50 pixels for a link unit content item type, an auction may determine that highest scoring combination is for two image content item type content items, a text content item type content item, and two link unit content item type content items. In some instances, the auction score may be based on a bid and/or a quality score.

The total length of the content items selected may be less than or equal to a dimension of the content item slot (e.g., the height of the content item slot if the content items are vertically arranged, or the width of the content item slot if the content items are horizontally arranged). In some instances, the total length of the selected content items may be greater than the dimension of the content item slot and one or more content items may be reduced in size to fit within the content item slot (e.g., by shrinking a content item or by cropping a content item). In other instances, the total length of the selected content items may be less than the dimension of the content item slot and one or more content items may be increased in size.

In some implementations, the selection of the two or more content items further depends on one or more factors. The factors may include a click through rate. For example, if it is determined that users click more on image content item type content items and not on a text content item type content items, then image content item type content items may be weighted more (e.g., by a click-through-weight or otherwise) to be selected over text content item type content items for selection. The factors may be determined based on data provided by the resource server 104 hosting the first-party content.

Data to effect display of the selected two or more content items may be outputted (step 510). In some instances, the data may include both positional data to indicate the positions of the selected content items in the content item slot and display data to effect display of each selected content item. The outputted data may be transmitted to a requesting device, such as requesting device 106 of FIG. 1, for display on a display of the requesting device or the outputted data may be transmitted to a resource server, such as resource server 104. As shown in FIG. 3, the web browser 208 may be used to display the selected content items in the hybrid content item slot 204 of a resource 202 along with the first-party content 206 using method 500. FIGS. 4A-4E illustrate various combinations of content item types and spatial configurations for content items in a content item slot.

In some implementations, the text content items, link unit content items, or any other content item type may be converted to an image content item type content item. Such a conversion may be performed prior to outputting the data to effect display of the selected two or more content items. Thus, the data to effect display of the selected content items may be all image content item type content items when transmitted to a requesting device or resource server. In other implementations, iframes (e.g., inline frames) may be used to effect display of different content item types next to each other in the hybrid content item slot. An iframe is an HTML element that allows for insertion of a frame or a document within the current HTML document.

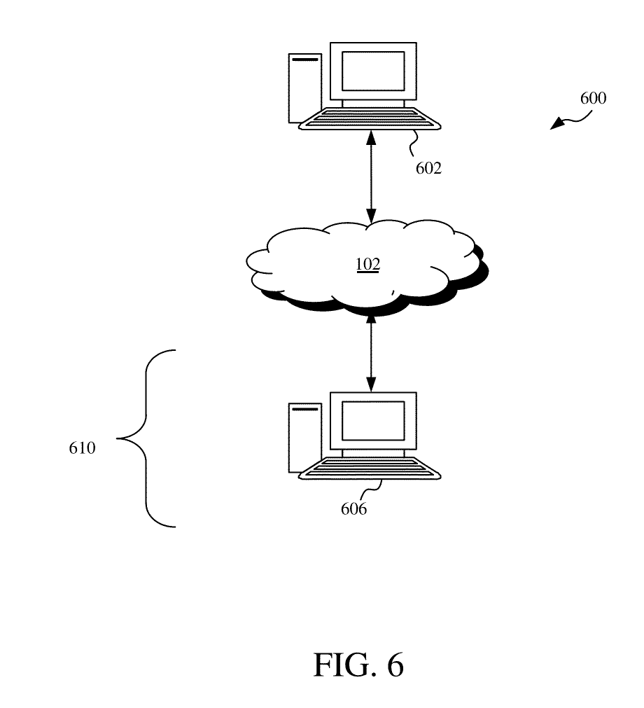

The system 100 and its components may include hardware elements, such as one or more processors, logic devices, or circuits. FIG. 6 illustrates an example implementation of a network environment 600 in which the system 100, process 200, and/or method 500 may be used. The network environment 600 may include one or more clients 602 that can be referred to as local machine(s) 602, client(s) 602, client node(s) 602, client machine(s) 602, client computer(s) 602, client device(s) 602, endpoint(s) 602, or endpoint node(s) 602) in communication with one or more servers 606 that can be referred to as server(s) 606, node 606, or remote machine(s) 606) via one or more networks 102. In some embodiments, a client 602 has the capacity to function as both a client node seeking access to resources provided by a server and as a server providing access to hosted resources for other clients 602.

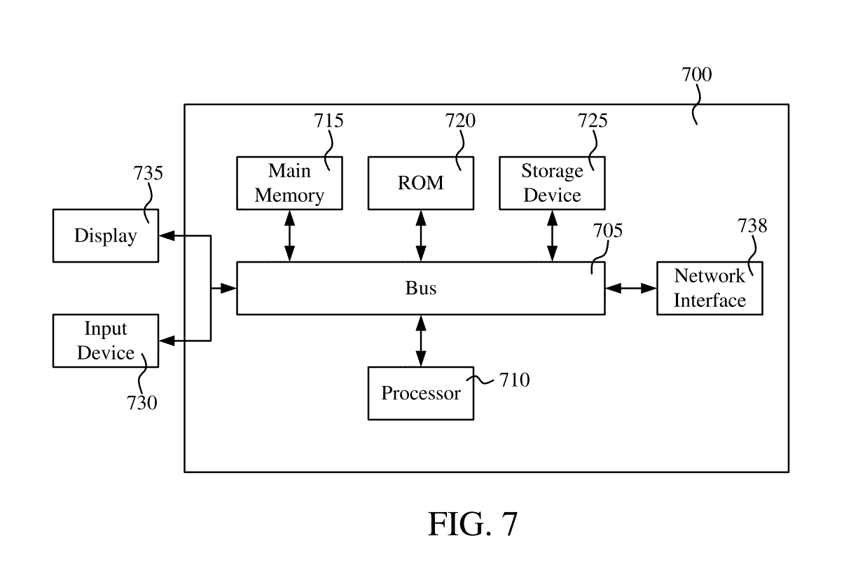

FIG. 7 is a block diagram of a computer system in accordance with an illustrative implementation. The computer system or computing device 700 can be used to implement the requesting devices 106, the data processing system 110, resource server 104, content server 108, etc. The computing system 700 includes a bus 705 or other communication component for communicating information and a processor 710 or processing module coupled to the bus 705 for processing information. The computing system 700 can also include one or more processors 710 or processing modules coupled to the bus for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information and command selections to the processor 710. In another implementation, the input device 730 may be integrated with the display 735, such as in a touch screen display. The input device 730 can include a cursor control, such as a mouse, a trackball, or cursor direction keys, for communicating direction information and command selections to the processor 710 and for controlling cursor movement on the display 735.

According to various implementations, the processes and/or methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes and/or method steps described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for several different applications, such as a web browser and several streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A method for providing two or more content items of different content item types for a content item slot, the method comprising:
receiving, by one or more data processors, data indicative of a size of a content item slot of a resource, wherein the data comprises at least one of a dimensional height and a dimensional width of the content item slot;
determining, by one or more data processors, a spatial configuration for content items for the content item slot;
determining, by one or more processors, a minimum length for each content item type of a plurality of content item types, wherein the determination is based, at least in part, on the data indicative of the size of the content item slot;
selecting, using one or more data processors, two or more content items based, at least in part, on the determined minimum length for each content item type and the data indicative of the size of the content item slot, wherein the two or more content items comprises a first content item of a first content item type and a second content item of a second content item type, wherein the first content item type and the second content item type are different; and
outputting data to effect display of the selected two or more content items.

2. The method of claim 1, wherein the determined spatial configuration for content items for the content item slot is a vertical arrangement or a horizontal arrangement.

3. The method of claim 1, wherein the determination of the spatial configuration is based on a comparison of the dimensional height to the dimensional width of the content item slot.

4. The method of claim 1, wherein the determination of the spatial configuration is based on a click-through-rate.

5. The method of claim 1, wherein the plurality of content item types comprises a text content item type, an image content item type, and a link unit content item type.

6. The method of claim 1, wherein the selection of the two or more content items is further based on a click-through-rate associated with each content item type.

7. The method of claim 1, wherein the selection of the two or more content items is performed via a content item auction.

8. The method of claim 1, wherein the determination of a minimum length is based on statistical data for each content item type.

9. The method of claim 1, wherein the data to effect display of the selected two or more content items comprises positional data for the two or more content items in the content item slot and display data for the two or more content items.

10. A system for providing two or more content items of different content item types for a content item slot, the system comprising:
one or more data processors; and
one or more storage devices storing instructions that, when executed by the one or more data processors, cause the one or more data processors to perform operations comprising:
receiving a dimensional height and a dimensional width of a content item slot of a resource;
determining a spatial configuration for content items for the content item slot;
determining a minimum length for each content item type of a plurality of content item types, wherein the determination is based, at least in part, on the determined spatial configuration;
selecting a plurality of content items based, at least in part, on the determined minimum length for each content item type and the dimensional height and dimensional width of the content item slot, wherein the plurality of selected content items comprises at least two content items of different content item types; and
outputting data to effect display of the selected plurality of content items.

11. The system of claim 10, wherein the determination of the spatial configuration is based on a click-through-rate.

12. The system of claim 11, wherein the spatial configuration comprises a vertical arrangement or a horizontal arrangement.

13. The system of claim 10, wherein the plurality of content item types includes at least two of a text content item type, an image content item type, a flash content item type, a link unit content item type.

14. The system of claim 10, wherein the selection of the plurality of content items is further based on a click-through-rate associated with each content item type.

15. The system of claim 10, wherein the determination of a minimum length for each content item type of a plurality of content item types is further based on statistical data for each content item type.

16. The system of claim 10 further comprising converting a first content item of the plurality of selected content items into an image content item type content item.

17. A computer-readable storage device storing instructions that, when executed by one or more data processors, cause the one or more data processors to perform operations comprising:
receiving a dimensional height and a dimensional width of a content item slot of a resource;
determining a minimum length for each content item type of a plurality of content item types and for each spatial configuration, wherein the determination is based, at least in part, on at least one of the dimensional height and the dimensional width of the content item slot;
determining a spatial configuration for content items for the content item slot, wherein the spatial configuration is based, at least in part, on the determined minimum lengths;
selecting two or more content items based, at least in part, on the determined minimum length for each content item type and the dimensional height and the dimensional width of the content item slot, wherein the two or more content items comprises a text content item type content item and an image content item type content item;
converting the text content item type content item into an image content item; and
outputting data to effect display of the converted text content item type content item and the image content item type content item.

18. The computer-readable storage device of claim 17, wherein the spatial configuration is a vertical arrangement or a horizontal arrangement.

19. The computer-readable storage device of claim 17, wherein the determination of the spatial configuration is further based on a click-through-rate associated with each content item type.

20. The computer-readable storage device of claim 17, wherein the determination of a minimum length for each content item type of a plurality of content item types is further based on statistical data for each content item type.
